(19) United States
(12) Patent Application Publication
(10) Pub. No.: US 2005/0279463 A1
(43) Pub. Date: Dec. 22, 2005

(54) Apparatus for dispensing labels to an operator without delay

(76) Inventor: Guy K. Ridenour, Angola, IN (US)

Correspondence Address: PEARNE & GORDON LLP, 1801 EAST 9TH STREET, SUITE 1200, CLEVELAND, OH, 44114-3108, US

(21) Appl. No.: 10/872,621

(22) Filed: Jun. 21, 2004

(51) Int. Cl. B65C 9/18; B65C 9/40

(52) U.S. Cl. 156/541; 156/64; 156/351

(57) ABSTRACT

A label dispensing apparatus of the invention dispenses labels from a feed roll of label web. The label web is comprised of backing and labels that are spaced apart from each other and adhered along a length of the backing. The apparatus includes a feed spindle for rotatably supporting the roll of label web. A label stripper is adapted to cause the labels to be stripped away from the backing. A take-up spool is adapted to receive the backing. A motor rotates the take-up spool effective to unwind the label web from the feed roll and to wind the backing onto the take-up spool. A holding roller is adapted to receive labels that have been stripped from the backing by the label stripper. The apparatus includes a workstation at which a plurality of articles are deposited. The workstation is adapted to enable an operator to remove one of the labels from the holding roller and to place the removed label on one of the articles. A gap sensor is adapted to sense the presence or absence of gaps between the labels on the backing and to send a signal indicating stoppage of the motor responsive thereto. A label presence sensor is adapted to sense the absence of a label from the holding roller and to send a signal indicating starting of the motor responsive thereto. Control devices are adapted to receive the signals from the label presence sensor and the gap sensor and to control starting and stopping of the motor, which in turn starts and stops rotation of the take-up spool. The invention may include two label dispensing devices used at the workstation. The invention also includes a method of operating the label dispensing device.

### FIELD OF THE INVENTION

The present invention relates to the field of machines for dispensing labels for application to articles such as packages.

### BACKGROUND OF THE INVENTION

Current designs of label dispensing machines include a mechanical lever arm that senses label position and stops with the label still inside a stripper. The stripper strips label from a backing of a web on which it is adhered. The label must be lifted off the sensing lever arm to move the machine forward so that the label clears and can then be removed by-hand by the operator. The operator must wait for the label to clear the machine. The machine cycles a new label forward until it touches the sensor and stops with the label still inside the stripper. This process delays the operator, forcing him to wait for the label to clear the stripper before it can be removed and placed on the packaging. The operator may apply labels to hundreds or thousands of packages each day. Therefore, the delay in waiting for each label adds up, which causes a significant reduction in productivity using the conventional machine.

Other fully automated machines can be used for applying labels to articles, but may not address the problem of delay faced by the operator-run device. Such fully-automated machines also require greater capital costs.

### SUMMARY OF THE INVENTION

In general, the present invention features a label dispensing apparatus for dispensing labels from a roll of label web. The label web is comprised of backing and labels that are spaced apart from each other and adhered along a length of the backing. The apparatus includes a feed spindle for rotatably supporting the roll of label web. A label stripper is adapted to cause the labels to be stripped away from the backing. A take-up spool is adapted to receive the backing. A motor rotates the take-up spool effective to unwind the label web from the feed roll and to wind the backing onto the take-up spool. A holding roller is adapted to receive labels that have been stripped from the backing by the label stripper. The apparatus includes a workstation at which a plurality of articles needing labels are deposited. The workstation is adapted to enable an operator to remove one of the labels from the holding roller and to place the removed label on one of the articles. A gap sensor (e.g., an electro-optical sensor) is adapted to sense the presence or absence of gaps between the labels on the backing and to send a signal indicating stoppage of the motor in the presence or absence of the gaps. A label presence sensor (e.g., an electro-optical sensor) is adapted to sense the absence of a label from the holding roller and to send a signal indicating starting of the motor in the absence of the label from the holding roller. Control devices, preferably electrical, are adapted to receive the signals from the label presence sensor and the gap sensor and to control starting and stopping of the motor responsive thereto, which in turn starts and stops rotation of the take-up spool.

A preferred aspect of the invention is directed to an apparatus that combines two label dispensing devices—the aforementioned label dispensing device and a second label dispensing device. The second label dispensing device comprises a second feed spindle for rotatably supporting a second roll of label web comprised of second backing and second labels that are spaced apart from each other and adhered along a length of the backing. The second labels have different characteristics than the first labels (e.g., different sizes). A second label stripper is adapted to cause the second labels to be stripped away from the second backing. A second take-up spool is adapted to receive the second backing. A second motor rotates the second take-up spool effective to unwind the second label web from the second feed roll and to wind the second backing onto the second take-up spool. A second holding roller is adapted to receive second labels that have been stripped from the second backing by the second label stripper. The second holding roller is located at the workstation, which is adapted to enable the operator to remove one of the second labels from the second holding roller and to place the removed second label on one of the articles. A second gap sensor is adapted to sense the presence or absence of gaps between the second labels on the second backing and to send a signal indicating stoppage of the second motor responsive thereto. A second label presence sensor is adapted to sense the absence of a second label from the second holding roller and to send a signal indicating starting of the second motor responsive thereto. Second control devices are adapted to receive the signals from the second label presence sensor and the second gap sensor and to control starting and stopping of the second motor responsive thereto, which in turn starts and stops rotation of the take-up spool.

Another preferred aspect of the invention is directed to a method of dispensing the labels. The roll of label web is rotatably supported on the feed spindle. The take-up spool is rotated to unwind the label web from the feed roll and to wind the backing onto the take-up spool. The labels are stripped away from the backing and received onto the holding roller. The presence or absence of gaps between labels on the backing is sensed with a gap sensor. A signal from the gap sensor is sent, indicating stoppage of rotation of the take-up spool in the presence or absence of the gaps. One of the labels is removed by-hand from the holding roller at the workstation and applied by-hand to one of a plurality of articles deposited at the workstation. The absence of a label from the holding roller is sensed by the label presence sensor. A signal is sent from the label presence sensor indicating starting of rotation of the take-up spool in the absence of one of the labels from the holding roller. The signals from the gap sensor and the label presence sensor are received by the control devices and starting and stopping of the take-up spool is controlled responsive thereto. After an operator removes one of the labels from the holding roller by-hand and applies the label to an article by-hand, the next label has already been positioned on the holding roller. Therefore, the operator can remove the next label from the holding roller without delay.

A preferred aspect of the invention is a method of using two label dispensing devices. The first device is used as described above. A method of using the second device comprises the following steps. The second roll of label web is rotatably supported on the second feed spindle. The second take-up spool is rotated to unwind the second label web from the second feed roll and to wind its backing onto the second take-up spool. The second labels are stripped away from the backing and received onto the second holding roller. The presence or absence of gaps between the second labels on their backing are sensed with the second gap sensor. A signal is sent from the second gap sensor indicating stoppage of rotation of the second take-up spool in the presence or absence of the gaps. One of the labels is removed by-hand from the second holding roller at the workstation and applied by-hand to one of the articles deposited at the workstation. The absence of a label from the second holding roller is sensed with the second label presence sensor. A signal is sent from this presence sensor indicating starting of rotation of the second take-up spool in the absence of one of the labels from the second holding roller. The signals from the second gap sensor and the second label presence sensor are received by the control devices, which control starting and stopping of the second take-up spool responsive thereto. After an operator removes one of the labels from the second holding roller by-hand and applies the label to an article by-hand, the next label has already been positioned on the second holding roller so that the operator can remove the next label without delay. In particular, the operator can select one of the labels from the two dispensing devices at the workstation, remove the selected label from the holding roller and apply the selected label to the article.

The label dispensing apparatus of the present invention offers advantages compared to prior art dispensing machines. The present invention overcomes the significant problem of the prior art machine, which requires the operator to wait for the label to clear the stripper before it can be removed and placed on packaging. The present invention delivers a label to the operator such that the operator can remove the label without delay. There is no need to wait for the machine to move forward to clear a label from the stripper. The present invention increases productivity in that the operator can place hundreds or thousands of labels on packaging each day without having to wait for the machine. The inventive machine can be adjusted to accommodate a wide range of widths and lengths of labels. It can also run two different sizes of labels at the same time, whereas current machines only allow an operator to run one size label at a time. An advantage of the use of two dispensing devices in the preferred embodiment is that the operator can select one of the labels from the two dispensing devices at the workstation, remove the selected label from the holding roller on which the label resides and apply the selected label to the article. This gives the operator more flexibility in selecting the appropriate size or kind of label and permits both labels to be used on one article.

Other embodiments of the invention are contemplated to provide particular features and structural variants of the basic elements. The specific embodiments referred to as well as possible variations of the features and advantages of the invention will become better understood from the accompanying drawings and the detailed description that follows.

### BRIEF DESCRIPTION OF THE DRAWINGS

FIG. 1 is a perspective view of a label dispensing apparatus constructed in accordance with the present invention;

FIG. 2 is a perspective view of one of the dispensing devices that can be used in the inventive apparatus shown in FIG. 1;

FIG. 3 is a perspective view of the apparatus of FIG. 1 without the label web present and showing two dispensing devices of the inventive apparatus;

FIG. 4 is a side elevational view of the apparatus shown in FIG. 1;

FIG. 5 is a front elevational view of the apparatus shown in FIG. 1;

FIGS. 6-8 are side elevational and detail views showing operation of the sensors used in the inventive apparatus; and

FIG. 9 is a schematic view showing an electrical circuit including electrical control devices that can be used in the inventive apparatus.

### DETAILED DESCRIPTION

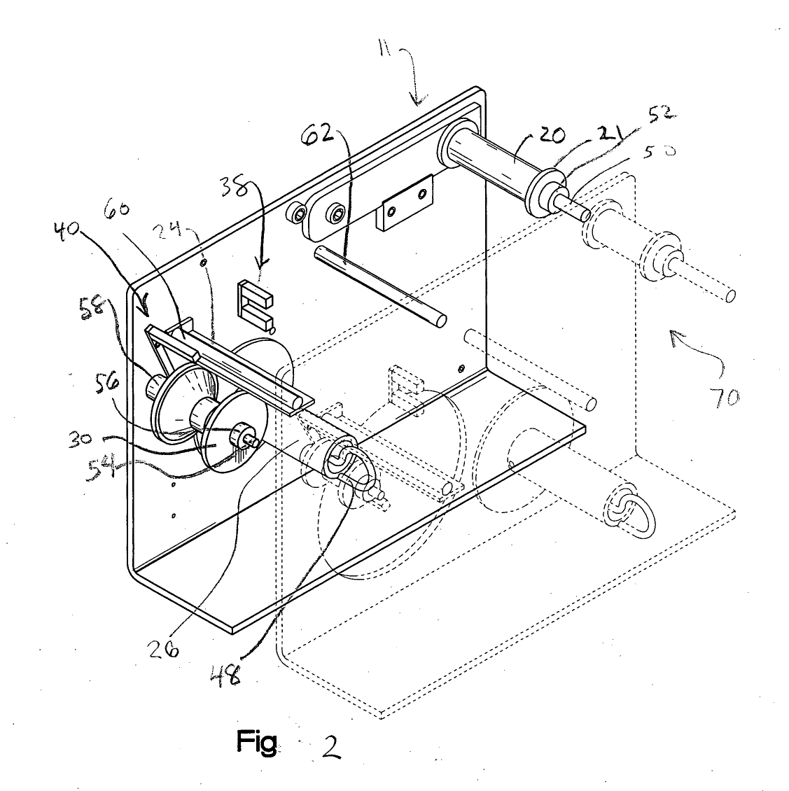

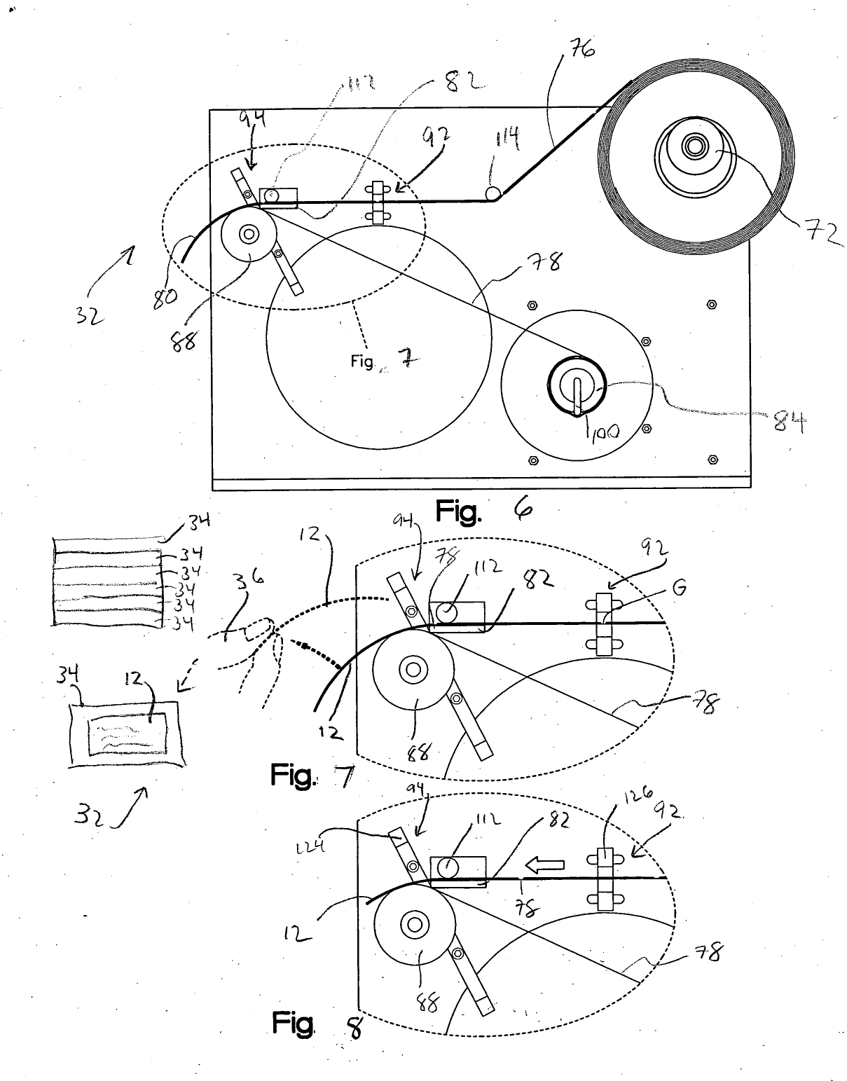

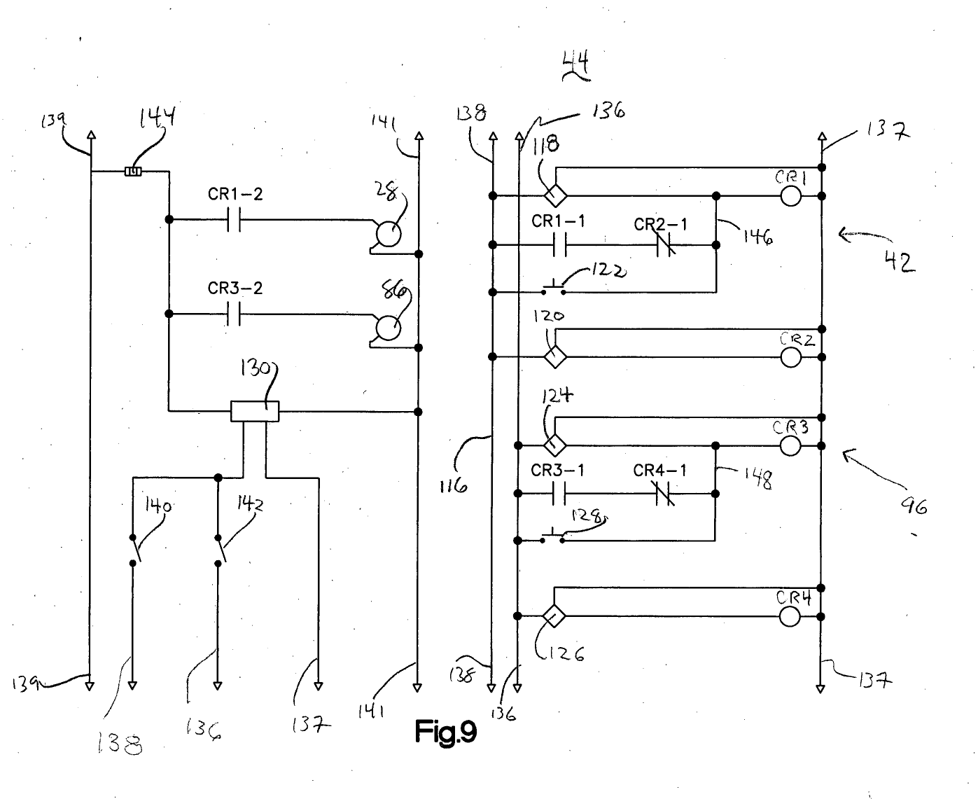

The present invention features a label dispensing apparatus 10 or first device 11 for dispensing labels 12 from a roll 14 of label web 16. The label web 16 is comprised of backing 18 (FIG. 4) and labels 12 spaced apart from each other and adhered along a length of the backing. The apparatus includes a feed spindle 20 (FIG. 2) having a hub 21 for rotatably supporting an internal tubular core 22 of the roll. A label stripper bar 24 strips the labels away from the backing. A rotatable take-up spool 26 receives the backing after the labels have been stripped from the backing. A motor 28 rotates the take-up spool effective to unwind the label web from the feed roll and to wind the backing onto the take-up spool. A holding roller or wheel 30 is adapted to receive labels 12 that have been stripped from the backing by the label stripper. The apparatus includes a workstation shown generally at 32 (FIG. 7) at which the holding roller is located and at which a plurality of articles 34 (e.g., packaged products) are periodically deposited by conveyor, by other equipment or by-hand. The workstation is adapted to enable an operator to remove one of the labels 12 by-hand (as represented schematically in FIG. 7 by the pictured hand 36) from the holding roller and to place the label 12 on one of the articles 34. Although the process shown in FIG. 6 shows the use of device 70, the same process is used by device 11. A gap sensor 38 is adapted to sense the presence of gaps between the labels on the backing and to send signals indicating stoppage of the motor in the presence of the gaps. A label presence sensor 40 is adapted to sense the absence of labels from the holding roller and to send signals indicating starting of the motor responsive thereto. Electrical control devices 42 included in an electrical circuit 44 (FIG. 9) are adapted to receive the signals from the label presence sensor and the gap sensor and to control starting and stopping of the motor, respectively, responsive thereto.

More specifically, the device includes a base member 46 on which the feed spindle, holding roller and take-up spool are rotatably fastened or arranged. As shown in FIG. 2, a take-up clamp 48 is used to attach the free end of the backing to the take-up spool. The feed spindle 20 is disposed on a shaft 50 mounted to the base and rotates on bearings 52 carried inside the feed spindle. All of the bearings referred to in this disclosure may be bronze sleeve bearings. A locking collar 52 fixes the feed spindle on the shaft. The holding roller is disposed on a wheel shaft 54 mounted to the base and rotates on bearings carried inside the holding roller. A locking collar 56 fixes the holding roller on the wheel shaft. A spacer 58 is positioned on the wheel shaft between the base and the holding roller. The take-up spool 26 is configured to engage a drive shaft of the motor 28 in a known manner effective to be driven by the motor drive shaft. The take-up spool may include a plate 59 for guiding the web.

The label presence sensor 48 and gap sensor 38 are connected to the base. The label presence sensor is located in a position that permits it to detect when a label has been removed from the holding roller. The gap sensor is located in a position that permits it to detect a gap between labels on the web. The stripper bar 24 is affixed to the base. A label guide or rod 60 is also affixed to the base and located adjacent the stripper bar to hold the label web down against the stripper bar so the backing is pulled tight around the edge of the stripper bar. A web guide 62 is affixed to the base and directs the web from the web feed spindle to the stripper bar.

The motor drives rotation of the take-up spool. Any motor known to those skilled in the art may be suitable for use in the present invention. One such suitable motor is an electric braking gear motor, which can stop the take-up spool immediately.

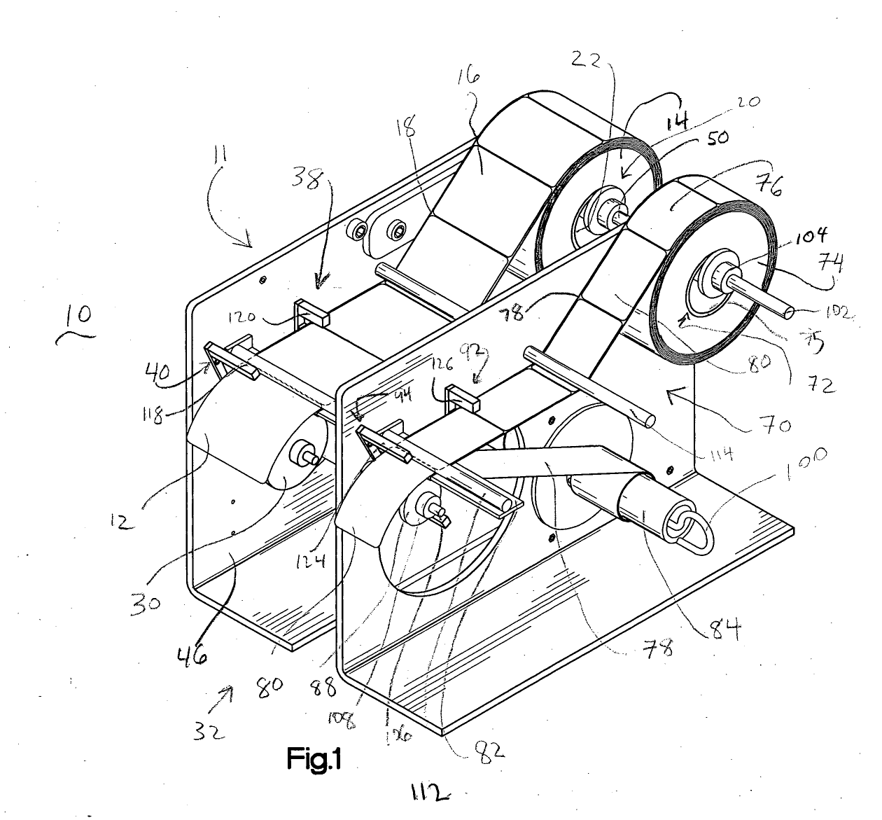

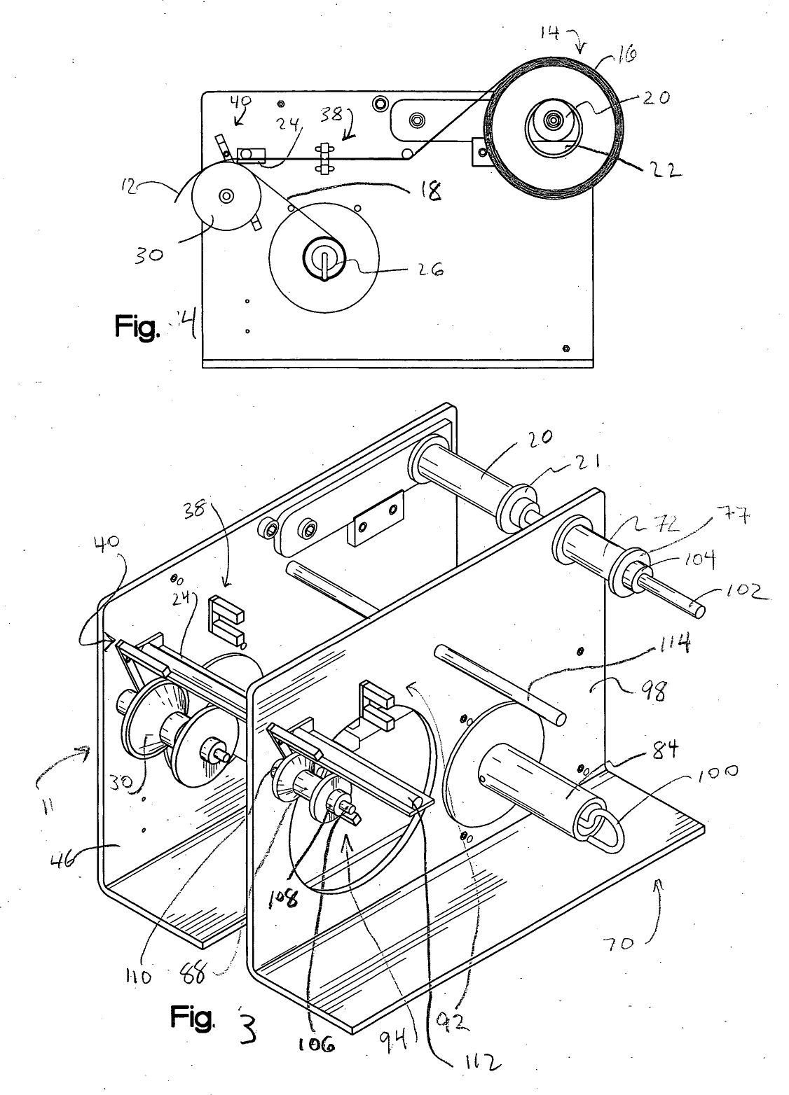

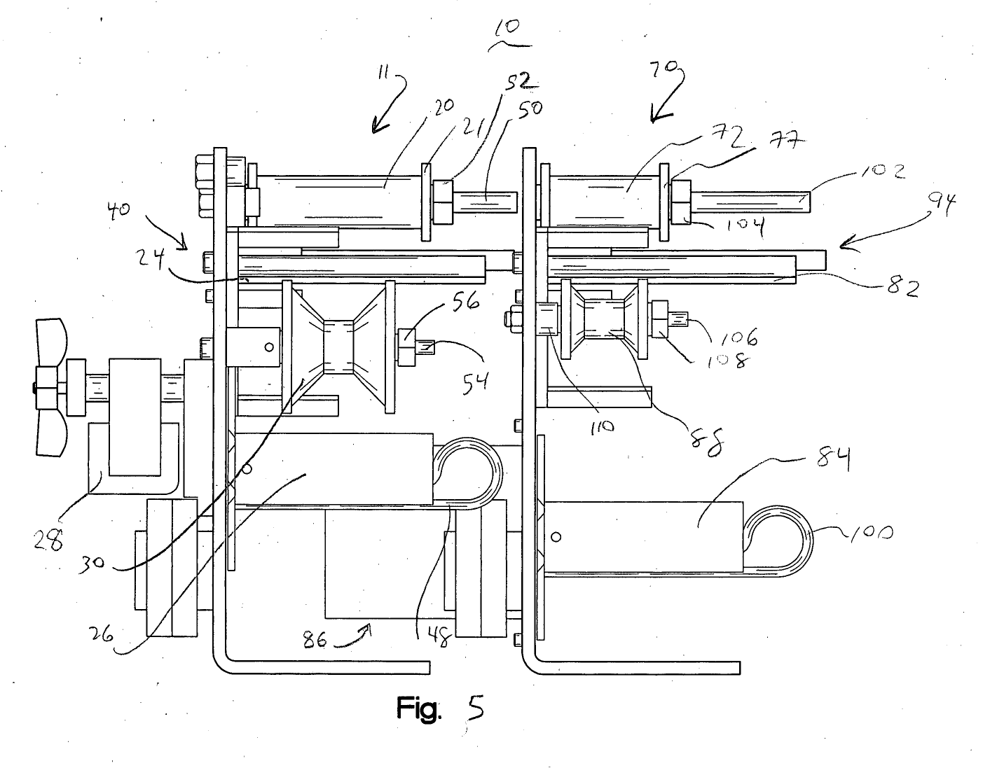

A preferred aspect of the invention combines two label dispensing devices—the first aforementioned label dispensing device 11 and a second label dispensing device 70. Referring to FIGS. 1 and 3, the label dispensing device 70 comprises a feed spindle 72 for rotatably supporting a roll 74 of label web 76 comprised of backing 78 and labels 80 that are spaced apart from each other and adhered along a length of the backing. The roll 74 includes a tubular core 75 that is disposed on hub 77 of the spindle. The labels 80 in this particular design are smaller than the labels 12. A label stripper bar 82 is adapted to cause the labels 80 to be stripped away from the backing. A take-up spool 84 is adapted to receive the backing. A motor 86 (obscured beneath a cover in FIG. 1) rotates the take-up spool 84 effective to unwind the label web 76 from the feed roll 74 and to wind the backing 78 onto the take-up spool 84. A holding roller 88 is adapted to receive the labels that have been stripped from the backing by the label stripper bar 82. The workstation 32 (FIGS. 1 and 7) is adapted to enable the operator to remove one of the labels from the holding roller and to place the removed label on one of the articles 34. A gap sensor 92 is adapted to sense the presence of gaps between the labels on the backing and to send signals indicating stoppage of the motor responsive thereto. A label presence sensor 94 is adapted to sense the absence of labels from the holding roller and to send signals indicating starting of the motor responsive thereto. Electronic control devices 96 are adapted to receive the signals from the label presence sensor and the gap sensor and to control starting and stopping of the motor.

More specifically, the label dispensing device 70 includes a base member 98 on which the feed spindle, holding roller and take-up spool are rotatably fastened or arranged. A take-up clamp 100 is used to attach the free end of the backing to the take-up spool. The feed spindle 72 is disposed on a shaft 102 affixed to the base and rotates on bearings carried inside the feed spindle. A locking collar 104 fixes the feed spindle on the shaft. The holding roller 88 is disposed on a wheel shaft 106 affixed to the base and rotates on bearings carried inside the holding roller. A locking collar 108 fixes the holding roller on the shaft. A spacer 110 is positioned on the wheel shaft between the base and the holding roller. The take-up spool 84 is configured to engage a drive shaft of the motor 86 in a known manner effective to be driven by the motor drive shaft.

The label presence sensor 94 and gap sensor 92 are connected to the base. The label presence sensor is located in a position that permits it to detect when a label has been removed from the holding roller. The gap sensor is located in a position that permits it to detect gaps between labels on the web. The stripper bar is affixed to the base. A label guide or rod 112 affixed to the base is located adjacent the stripper bar to hold the label web down against the stripper bar as described above. A web guide 114 affixed to the base, directs the web from the feed spindle to the stripper bar.

Referring now to a method of dispensing labels from a roll of label web using the label dispensing apparatus 70 of the present invention (FIGS. 6-8), a roll of label web is rotatably supported on the feed spindle 72. Backing from the roll is threaded against the web guide, between the stripper and label guide and to the take-up spool 84. The free end of the backing is clamped to the take-up spool. As the take-up spool 84 is rotated by the motor 86, the label web is unwound from the roll on the feed spindle. The stripper bar strips labels away from the backing onto the holding roller. The backing without labels is wound onto the take-up spool. The labels are stiffer than the backing. Therefore, when the backing is sharply bent between the label guide 112 and stripper bar 82 and between the stripper bar 82 and holding roller 90, the labels peel off the backing and adhere or rest lightly on the holding roller. The backing may or may not touch the holding roller depending on the amount of backing that has accumulated on the take-up spool. As the label moves forward, the backing is pulled around the stripper bar and the forward motion of the label causes the holding roller to rotate.

When the presence of a gap G between successive labels on the backing is sensed by the eye of the gap sensor as shown in FIG. 7, a signal is sent from the gap sensor indicating stoppage of the motor, which stops rotation of the take-up spool. At this time, one of the labels is positioned on the holding roller, clear of the stripper and is ready for removal. The label is removed by-hand from the holding roller at the workstation and applied by-hand to one of a plurality of articles 34 that are periodically deposited at the workstation 32. Once the label has been removed from the holding roller, the label presence sensor senses its absence from the holding roller. A signal is then sent from the label presence sensor indicating powering of the motor, which starts rotation of the take-up spool (FIG. 8). Rotation of the take up spool then advances the web in the direction of the arrow in FIG. 8 until the next label begins to be stripped from the backing and positioned on the holding roller. Once the next gap G is sensed by the gap sensor, rotation of the take-up spool stops. The sequence of events is repeated for subsequent labels of the web. The signals from the gap sensor and the label presence sensor are received electronically and starting and stopping of the take-up spool is controlled responsive thereto as discussed in more detail below. In accordance with the invention, after the operator removes one of the labels from the holding roller by-hand and applies the label to an article by-hand, the next label has already been positioned on the holding roller clear of the stripper bar so that the operator can remove the next label from the holding roller without delay. The invention may consist of only a single label dispensing device 11.

A preferred embodiment of the present invention is a method of using two label dispensing devices 11 and 70 together at a single workstation. As shown in FIGS. 2 and 4, the tubular core 22 of the roll 14 is received on the spindle 20 and restrained by hub 21. The device is set-up by threading the backing from the roll in position against the web guide, between the stripper and label guide and to the take-up spool 26. The free end of the backing is clamped to the take-up spool. As the take-up spool is rotated clockwise by the motor 28 (as viewed in FIG. 4), the label web is unwound from the roll on the feed spindle. The stripper bar 24 strips labels away from the backing onto the holding roller 30 in the same manner as described earlier. The backing without labels is wound onto the take-up spool.

When the presence of a gap between successive labels on the backing is sensed by the gap sensor 38, a signal is sent from the gap sensor indicating stoppage of the motor which stops rotation of the take-up spool. At this time, one of the labels is positioned on the holding roller, clear of the stripper and is ready for removal. When it is needed, the operator removes the label by-hand from the holding roller at the workstation and applies that label by-hand to one of a plurality of articles 34 deposited at the workstation 32. Once the label is removed from the holding roller, the label presence sensor 40 senses its absence from the holding roller. A signal is then sent from the label presence sensor indicating powering of the motor, which starts rotation of the take-up spool. Rotation of the take-up spool then advances the web. The next label begins to be stripped from the backing and begins to be positioned on the holding roller. Once the next gap is sensed by the gap sensor it cuts off power to the motor which, in turn, stops rotation of the take-up spool. This sequence of events, in which the label presence sensor starts rotation of the take-up spool when a label has been removed from the holding roller and the gap sensor stops rotation of the take-up spool when a gap has been sensed, is repeated for subsequent labels. The signals from the gap sensor 38 and the label presence sensor 40 are received electronically and starting and stopping of the take-up spool is controlled responsive thereto, as discussed in more detail below.

After the operator removes one of the labels from the holding roller 30 by-hand and applies the label to the article by-hand, the next label has already been positioned on the holding roller. Therefore, the operator can remove the next label from the holding roller without delay. The operator can select one of the labels from the two dispensing devices at the workstation, remove the selected label from the holding roller and apply the selected label to the article. This gives the operator more flexibility in selecting the appropriate size or kind of label and permits both labels to be used on one article. That is, two labels can be applied to the same or different packages without delay. Those skilled in the art will appreciate in view of this disclosure that the invention contemplates the use of more than two dispensing devices converging at a workstation as well as multiple workstations and interactions between workstations, such as successive application of labels to packaging. Conveyors or other devices for continually depositing articles at the workstation and for removing labeled articles from the workstation, may be used.

The electro-optical sensing and powering of the motor for rotation of the take-up spool, will now be described in more detail by reference to the electrical circuit 44 shown in FIG. 9. It will be apparent from viewing FIG. 9 that the circuit 44 includes electrical control devices 42 for operation of the large label dispenser 11 and electrical control devices 96 for operation of the small label dispenser 70, interconnecting by electrical conductors or wire 116. This circuit exemplifies one specific way to control the operation of the take-up spools in response to optical inputs to the gap and presence sensors of each dispensing device. Those skilled in the art will recognize other circuits and electrical control devices that may be used, as in the case of using non-optical sensors, which are within the scope of the present invention.

The electrical control devices 42 for the large label dispenser include eye 118 of the label presence sensor 40, relay CR1, contacts CR1-1 and CR1-2, eye 120 of the label gap sensor 38, relay CR2 and contacts CR2-1. Also included is momentary toggle switch 122, which can momentarily start the motor 28 and rotation of the take-up spool 26. The electrical control devices for the small label dispenser include eye 124 of the small label presence sensor 94, relay CR3, contacts CR3-1 and CR3-2, eye 126 of the small label gap sensor 92, relay CR4 and contacts CR4-1. One example of suitable relays are Super MY Series relays supplied by Grainger Inc. Also included is momentary toggle switch 128, which can momentarily start the motor 86 and rotation of the take-up spool 84. The momentary toggle switch is used to initiate a machine cycle if a label covers the eye during the loading process.

The label presence sensor and gap sensor are preferably electro-optical sensors. Other sensors might also be suitable for use in the present invention such as magnetic sensors, mechanical sensors, ultrasonic sensors and the like. However, use of electro-optical sensors is preferable in the present invention. The eyes of the label presence and gap sensors in the label dispensing devices take the form of C-shaped structures mounted to the bases with aligned, opposing apertures that support fiber-optic cable for emitting a modulated light beam and receiving light, relative to the web or label. The set-up, construction and operation of such optical sensors is well known to those skilled in the art in view of this disclosure. In general, each of the electro-optical sensors includes a light source such as an LED emitter and a receiver or photodetector that enables detection of variations of characteristics of the emitted light upon contact with objects. Fiber optic cable extends from the emitter to one aperture of the eye and from the opposing aperture of the eye to the receiver, enabling the light to be directed between the emitter and receiver. The fiber optic cables for the emitter and receiver are located on each side of the label web and labels for the gap eye and the presence sensor eye, respectively, so as to “look through” the web or labels and detect variations in the light. The emitter, receiver, cable and other components of the sensors are not shown as they are well known to those skilled in the art in view of this disclosure. Details of suitable sensors are provided in U.S. Pat. Nos. 5,808,296 and 4,356,393, which are incorporated herein by reference in their entireties. One example of suitable sensors are D12 Series photoelectric sensors, supplied by Banner Engineering Corp. One example of suitable fiber optic cables are Pico-Style Quick-Disconnect Cables supplied by Banner Engineering Corp.

The circuit includes a (e.g., DC) power supply 130 and the motors 28, 86 for each of the large and small label dispensing devices, respectively. The circuit includes a circuit 136 for the small label dispenser and a circuit 138 for the large label dispenser. Alternatively, completely separate circuits could be used for each label dispensing device. The circuit 138 for the large label dispenser includes a main switch 140. The circuit 136 for the small label dispenser includes a main switch 142. The circuit 44 includes a fuse 144. Wires or electrical conductors 137, 139 and 141 complete the circuit.

Referring to FIG. 9, when the eye 118 of the large label presence sensor senses that there is no label on the holding roller 30, it passes current to relay CR1. This closes contacts Cr1-1, passing current along loop 146. It also closes contacts Cr1-2, which powers the motor 132, thereby causing the take-up spool 26 to rotate and drawing web from the feed roll. The web is drawn from the feed roll in an amount that is predetermined to enable positioning of the next label onto the holding roller. That is, the web continues to move toward the take-up spool until the eye 120 of the gap sensor 38 senses a gap G between the next labels on the web. At this time, current is allowed to pass to the relay CR2. This opens contacts CR2-1 and cuts off power to the motor 132. This stops rotation of the take-up spool 26 immediately. At this point when the advancement of the web has stopped, the relative distances between components of the apparatus have been set such that the next label is received onto the holding roller clear of the stripper. The gap sensor can be adjusted for different size labels.

The electrical control devices of the label dispensing device 70 operate in a similar manner. Once the eye 124 of the small label presence sensor 94 senses that a label has been removed from the holding roller 88, it allows current to pass to relay CR3 which closes contacts CR3-1, passing current along loop 148. This closes contacts CR3-2, which powers the motor 134 thereby causing the take-up spool 84 to rotate and drawing web from the web feed roll. The web is drawn from the feed roll in an amount that is predetermined to enable positioning of the next label onto the holding roller. That is, the web continues to move toward the take-up spool until the eye 126 of the small label gap sensor 92 senses the next gap between labels on the web. At this point current is allowed to pass to relay CR4, which open contacts CR4-1 and cuts off power to the motor 134. This stops rotation of the take-up spool 84. At this point when the advancement of the web has stopped, the relative distances between components of the apparatus have been set such that the next label is received onto the holding roller clear of the stripper.

Although the invention has been described in its preferred form with a certain degree of particularity, it will be understood that the present disclosure of the preferred embodiments has been made only by way of example and that various changes may be resorted to without departing from the true spirit and scope of the invention as hereafter claimed.

1. A label dispensing apparatus for dispensing labels from a roll of label web to an operator without delay, the label web being comprised of backing and labels that are spaced apart from each other and adhered along a length of the backing, comprising:
a feed spindle for rotatably supporting the roll of label web;
a label stripper adapted to cause said labels to be stripped away from said backing;
a take-up spool adapted to receive said backing;
a motor that rotates said take-up spool effective to unwind said label web from said feed roll and to wind said backing onto said take-up spool;
a holding roller adapted to receive labels that have been stripped from said backing by said label stripper;
a workstation at which a plurality of articles are deposited, wherein said workstation is adapted to enable an operator to remove one of said labels from said holding roller and to place said removed label on one of said articles;
a gap sensor adapted to sense the presence or absence of gaps between said labels on said backing and to send a signal indicating stoppage of said motor responsive thereto;
a label presence sensor adapted to sense the absence of a label from said holding roller and to send a signal indicating starting of said motor responsive thereto; and
control devices adapted to receive said signals from said label presence sensor and said gap sensor and to control starting and stopping of said motor responsive thereto.

2. The apparatus of claim 1 wherein said gap sensor is an electro-optical sensor adapted to sense the presence of a gap between adjacent said labels on said backing and said control devices are electrical control devices.

3. The apparatus of claim 1 wherein said label presence sensor is an electro-optical sensor adapted to sense the absence of one of said labels on said holding roller and said control devices are electrical control devices.

4. The apparatus of claim 1 further comprising a second label dispensing apparatus comprising:
a second feed spindle for rotatably supporting a second roll of label web comprised of second backing and second labels that are spaced apart from each other and adhered along a length of the second backing, said second labels having different characteristics than said first labels;
a second label stripper adapted to cause said second labels to be stripped away from said second backing;
a second take-up spool adapted to receive said second backing;
a second motor that rotates said second take-up spool effective to unwind said second label web from said second feed roll and to wind said second backing onto said second take-up spool;
a second holding roller adapted to receive second labels that have been stripped from said second backing by said second label stripper;
said second holding roller being located at said workstation, wherein said workstation is adapted to enable the operator to remove one of said second labels from said second holding roller and to place said removed second label on one of said articles;
a second gap sensor adapted to sense the presence or absence of gaps between said second labels on said second backing and to send a signal indicating stoppage of said second motor responsive thereto;
a second label presence sensor adapted to sense the absence of a second label from said second holding roller and to send a signal indicating starting of said second motor responsive thereto; and
second control devices adapted to receive said signals from said second label presence sensor and said second gap sensor and to control starting and stopping of said second motor responsive thereto.

5. A method of dispensing labels from a roll of label web to an operator without delay, the label web being comprised of backing and labels that are spaced apart from each other and adhered along a length of the backing, comprising:
rotatably supporting the roll of label web on a feed spindle;
rotating a take-up spool to unwind said label web from said feed roll and to wind said backing on said take-up spool;
stripping said labels away from said backing;
receiving labels that have been stripped from said backing onto a holding roller;
sensing the presence or absence of gaps between said labels on said backing with a gap sensor and sending a signal from said gap sensor indicating stoppage of rotation of said take-up spool responsive thereto;
removing by-hand one of said labels from said holding roller at a workstation and applying by-hand said label to one of a plurality of articles deposited at the workstation;
sensing the absence of a label from said holding roller with a label presence sensor and sending a signal from said label presence sensor indicating starting of rotation of said take-up spool responsive thereto; and
receiving said signals from said gap sensor and said label presence sensor and controlling starting and stopping of said take-up spool responsive thereto,
wherein after an operator removes one of said labels from said holding roller by-hand and applies said label to an article by-hand, the next label has already been positioned on said holding roller so that said operator can remove the next label from the holding roller without delay.

6. The method of claim 5 further comprising dispensing second labels from a second roll of label web, the second label web being comprised of second backing and second labels that are spaced apart from each other and adhered along a length of the second backing, said second labels having different characteristics than said labels, comprising:
rotatably supporting the second roll of label web on a second feed spindle;
rotating a second take-up spool to unwind said second label web from said second feed roll and to wind said second backing onto said second take-up spool;
stripping said second labels away from said second backing;
receiving second labels that have been stripped from said second backing onto a second holding roller;
sensing the presence or absence of gaps between said second labels on said second backing with a second gap sensor and sending a signal from said second gap sensor indicating stoppage of rotation of said second take-up spool responsive thereto;
removing by-hand one of said second labels from said second holding roller at a workstation and applying by-hand said second label to one of the articles deposited at the workstation;
sensing the absence of a second label from said second holding roller with a second label presence sensor and sending a signal from said second label presence sensor indicating starting of rotation of said second take-up spool responsive thereto; and
receiving said signals from said second gap sensor and said second label presence sensor and controlling starting and stopping of said second take-up spool responsive thereto,
wherein after an operator removes one of said second labels from said second holding roller by-hand and applies said second label to the article by-hand, the next second label has already been positioned on said second holding roller so that said operator can remove the next second label from the second holding roller without delay.

7. The method of claim 6 wherein said operator selects one of said label and said second label at the workstation, removes said selected label from the holding roller on which said selected label resides and applies said selected label to the article.
